(19) United States
(12) Patent Application Publication
(10) Pub. No.: US 2014/0084202 A1
(43) Pub. Date: Mar. 27, 2014

(54) SEAL DISK WITH A PLURALITY OF HARDNESSES

(71) Applicant: EMERSON PROCESS MANAGEMENT REGULA, Mckinney, TX (US)

(72) Inventor: Jason S. Mevius, McKinney, TX (US)

(73) Assignee: EMERSON PROCESS MANAGEMENT REGULATOR TECHNOLOGIES, INC., Mckinney, TX (US)

(21) Appl. No.: 13/629,345

(22) Filed: Sep. 27, 2012

(51) Int. Cl. F16K 13/00

(52) U.S. Cl. CPC F16K 13/00
USPC 251/359

(57) ABSTRACT

A seal disk for a fluid flow control valve, such as a fluid regulator, has a body formed of elastomeric material having a first hardness at a seal face and a second hardness spaced apart from the seal face along the thickness. The elastomeric material is softer at the seal face and harder spaced away from the seal face.

### FIELD OF THE INVENTION

The present invention relates generally to a seal disk for a flow control valve, such as a fluid regulator, and more particularly, such a seal disk having a plurality of hardnesses.

### BACKGROUND

The pressure at which typical gas distribution systems supply gas may vary according to a number of factors. These factors may include, for example, the demands placed on the system, the climate, the source of supply, and/or other factors. However, most end-user facilities equipped with gas appliances such as furnaces, ovens, etc., require the gas to be delivered in accordance with a predetermined pressure, and at or below a maximum capacity of the end-user appliance. Therefore, process fluid regulators are implemented in these distribution systems in order to ensure that the delivered gas meets the requirements of the end-user facilities. Process fluid regulators are also used to regulate the delivery of liquids to achieve similar functionalities.

A common process fluid regulator includes a regulator body, a control element, and an actuator. The regulator body defines a fluid flow path, a fluid inlet, and a fluid outlet. An orifice defining a valve seat is operatively disposed in the body along the fluid flow path between the fluid inlet and the fluid outlet. The fluid flow path extends from the fluid inlet, through the orifice, and to the fluid outlet. The control element shifts to regulate the flow of fluid along the fluid flow path through the orifice. The control element sealingly engages the valve seat in a closed position, and is spaced away from the valve seat in an open position. In a manner well understood in the art, the actuator is operatively connected to the regulator body and the control element to control the position of the control element relative to the orifice in response to pressure changes in the fluid flow path to maintain a the process fluid pressure within a preselected range, for example, at the fluid outlet.

FIG. 1 shows an isolated and enlarged detail of portions of a typical valve trim for a process fluid regulator, including a flow control element 10, a valve stem 12, and an orifice 14. The orifice 14 has the form of a cylindrical tube and is secured to a regulator body 16, for example, with outer threads 18 that engage complementary inner threads 20 in the regulator body 16, and surrounds and forms an aperture 22 through which fluid in the fluid flow path must pass. A valve seat 24 is defined along the upper edge or annular lip of the orifice 14. The flow control element 10 is carried at a distal end of the valve stem 12. The flow control element 10 includes a mounting portion 26, such as a socket that receives the distal end of the valve stem 12, and a seal disk 28 arranged to sealingly engage the valve seat 24. The seal disk 28 is disposed at a front side of the flow control element 10, and the mounting portion 26 is disposed at a rear side of the flow control element 10 opposite the front side. In the exemplary arrangements shown in FIG. 1, the seal disk 28 includes a circular seal face 30 having a larger diameter than the valve seat 24. The mounting portion 26 fits tightly and/or is locked onto the distal end of the valve stem 12 such that the seal face 30 is arranged to sealingly engage the valve seat 24 when the flow control element 10 is moved to a lockup position, i.e., the extreme or maximum closed position of the control element 10 that completely stops fluid flow through the aperture 22 and thus the regulator body 16.

At least the seal disk 28, and in the present example, the entire flow control element 10, is typically made of rubber or similar resilient compressible sealing material having a substantially homogeneous makeup throughout the entire seal disk 28. For ease of reference, the term “elastomeric material” is used hereinafter to refer to all commonly used resilient compressible sealing materials in the valve and process fluid regulator industry, such as rubber, nitrile rubber, ethylene propylene diene monomer rubber, and other natural and synthetic rubber compounds, polymers, and/or elastomers as would be understood in the valve seal art.

When the seal disk 28 engages the valve seat 24, and particularly in the lockup position, the valve seat 24 presses into the elastomeric material of the seal disk 28 and may shear and/or cut the seal face 30 of the seal disk 28. A softer elastomeric material is generally more prone to sustaining shearing wear and/or being cut by the valve seat 24 than a harder elastomer material. Therefore, the seal disk 28 is typically formed of a harder material throughout the body of the seal disk 28, such as an elastomer having a durometer between about 70 and 90, to prevent the seal face 30 from excessive shearing wear or cutting against the valve seat 24 during operation of the flow control element 10. However, using a harder material throughout the body of the seal disk 28 also increases the amount of actuation force needed to seal the seal disk 28 against the valve seat 24, especially during lockup. Increases in the actuation force required to seal the orifice 14 can degrade performance characteristics of a flow control valve, which can be particularly troublesome in fluid pressure regulators.

### SUMMARY

In accordance with some exemplary aspects according to the teachings of the present disclosure, a seal disk is provided for a fluid flow control valve, such as a fluid regulator. The seal disk has a body having a thickness extending from a front side to a rear side, and defining a sealing surface at the front side. The sealing surface is arranged to sealingly engage a valve seat, and the body is made of an elastomeric material or other suitable material such as a rubber compound. The elastomeric material has a first hardness at the seal face and a second hardness spaced apart from the seal face along the thickness, wherein the elastomeric material is softer at the seal face and harder spaced away from the seal face toward the rear side.

In accordance with other exemplary aspects according to the teachings of the present disclosure, a fluid control valve includes a valve body, a valve seat, a valve stem, and a seal disk operatively carried by the valve stem. The valve stem is arranged to selectively urge the seal disk into sealing engagement against the valve seat. The seal disk includes a body having a thickness extending from a front side to a rear side, and defining a sealing surface at the front side. The sealing surface is arranged to sealingly engage a valve seat. The body is made of an elastomeric material or other suitable material such as a rubber compound. The elastomeric material has a first hardness at the seal face and a second hardness spaced apart from the seal face along the thickness, and the material is softer at the seal face and harder spaced away from the seal face toward the rear side.

In further accordance with any one or more of the foregoing exemplary aspects, a seal disk, fluid control valve, and/or a fluid regulator further optionally may include any one or more of the following preferred forms.

In some preferred forms, the material at the seal surface has a hardness durometer rating of between about 40 and about 60 as measured in accordance with ASTM D2240-05(2010) Standard Test Method for Rubber Property-Durometer Hardness. (All durometer ratings provided herein are in reference to this ASTM D2240-05(2010) standard.)

In some preferred forms, the elastomeric material in the body portion spaced away from the seal face has a hardness durometer rating of between about 70 and about 90.

In some preferred forms, the hardness of the elastomeric material changes gradually and/or continuously along the thickness between the seal surface and the body portion spaced away from the seal face. The hardness may change at a substantially constant gradient across the thickness. As an alternative, the hardness may change at a changing or variable gradient across the thickness.

In some preferred forms, the seal disk is formed of two or more layers of the elastomeric material, including at least a first layer of the material having a first thickness and a second layer of the material having a second thickness. The seal surface may be defined by the first layer, and the first layer of the material may have the first hardness. The second layer may have the second hardness, and the first layer of material may be secured against the second layer of the material. The first layer of the material may be secured to the second layer of the material.

In some preferred forms, at least a third layer of the elastomeric material is secured to the second layer of elastomeric material, and the third layer may be disposed between the first layer and the second layer. Alternatively, the second layer may be disposed between the first layer and the third layer.

In some preferred forms, one or more of the layers of the suitable material has a substantially constant hardness throughout the respective thickness. One or more of the layers of the material may have a gradually changing or variable hardness across the respective thickness.

In some preferred forms, the elastomeric material is a rubber compound, or other suitable material.

In some preferred forms, the fluid control valve is a fluid regulator, and the valve body is a regulator body.

In some preferred forms, and in any combination with any one or more of the preceding aspects and/or preferred forms, the first hardness is between approximately 40-60 durometer.

In some preferred forms, and in any combination with any one or more of the preceding aspects and/or preferred forms, the second hardness is between approximately 70 and 90 durometer.

Additional optional aspects and forms are disclosed, which may be arranged in any functionally appropriate manner, either alone or in any functionally viable combination, consistent with the teachings of the disclosure. Other aspects and advantages will become apparent upon consideration of the following detailed description.

### BRIEF DESCRIPTION OF THE DRAWINGS

FIG. 1 is a cross-sectional view of portions of a typical valve trim.

FIG. 2 is a partial cut-away side view of a fluid regulator with a valve trim including a seal disk in an exemplary arrangement in accordance with the teachings of the present disclosure.

FIG. 3 is an enlarged cross-sectional view of the valve trim taken at the circumscribed portion of FIG. 2 illustrating the exemplary seal disk in greater detail.

FIG. 4 is an enlarged cross-sectional view taken at the circumscribed portion of FIG. 2 and illustrating the seal disk in another exemplary arrangement in accordance with the teachings of the present disclosure in greater detail.

FIG. 5 is an enlarged cross-sectional view illustrating portions of a valve trim including a seal disk in yet another exemplary arrangement in accordance with the teachings of the present disclosure in greater detail.

### DETAILED DESCRIPTION

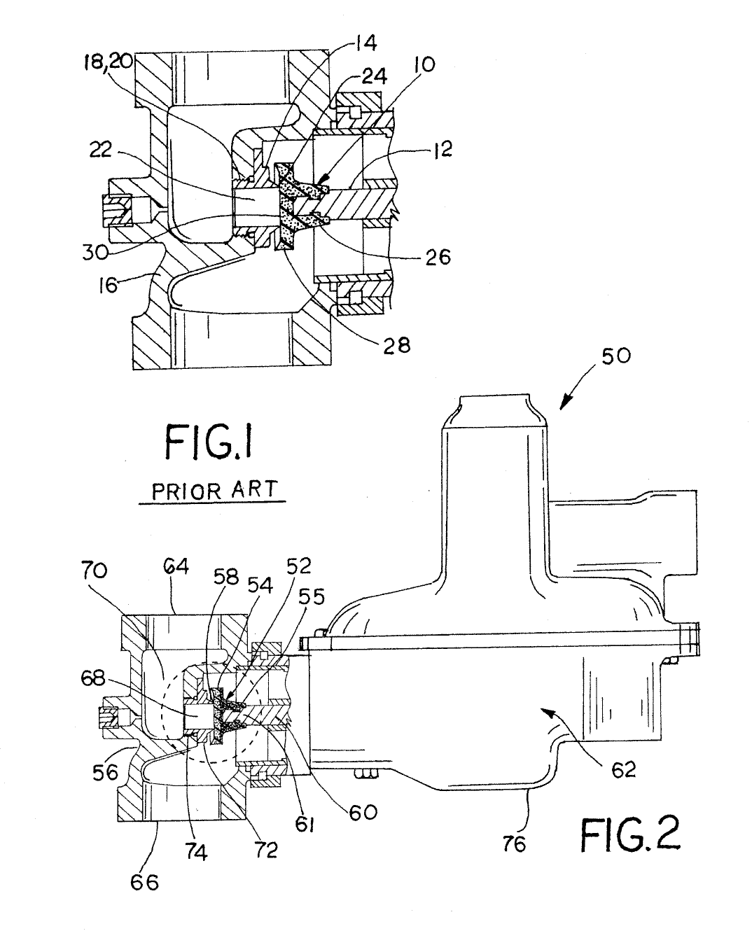

In the exemplary arrangement of FIGS. 2 and 3, a flow control valve, such as found in a fluid regulator 50, is provided with a flow control element 52 including a seal disk 54 according to the teachings of the present disclosure and a mounting portion 55. The fluid regulator 50 is a commonly known fluid regulator having a valve body, such as a regulator body 56, a flow control member, such as the flow control element 52, a valve seat 58, a valve stem 60, and an actuator 62. The flow control element 52 is operatively attached to the valve stem 60, for example with a first end 61 of the valve stem 60 disposed in a socket 63 defined in the mounting portion 55 of the flow control element 52. The actuator 62 is operatively connected to the regulator body 56 and a second end of the valve stem 60 to shift the control element 52 between an open position spaced from the valve seat 58 and a closed position engaged against the valve seat 58. The actuator 62 thereby regulates and/or maintains outlet fluid pressure from the regulator body 56 within a preselected pressure range, or set pressure, in a manner understood in the art. However, the seal disk 54 is not limited to use with a fluid regulator, but rather may also be used in other types of flow control valves as will be apparent upon review of the description herein.

The regulator body 56 defines an inlet 64, an outlet 66, an aperture 68 between the inlet 64 and the outlet 66, and a fluid flow path 70 extending through the aperture 68 from the inlet 64 to the outlet 66. The valve seat 58 is preferably defined by a rim of an orifice 72 surrounding the aperture 68. The orifice 72 preferably has a generally hollow cylindrical body and is secured to the regulator body 56, for example, by threads 74, to surround the aperture 68. The valve seat 58 is preferably circular. The flow control element 52 carries the seal disk 54 and shifts between the closed position, which stops fluid flow through the aperture 68, and a fully open position, which allows a maximum fluid flow through the aperture 68.

The actuator 62 is arranged to shift the flow control element 52 between the closed position and the fully open position in response to changes in fluid pressure at the outlet 66 in a manner understood in the art. The actuator 62 in this exemplary arrangement is a diaphragm regulator, which includes a flexible diaphragm (not visible) disposed inside an actuator housing 76 and operatively connected to the valve stem 60 by a linkage (not visible). The diaphragm shifts in response to changes in outlet fluid pressure at the outlet 66 to shift the control element 52 and thereby maintain the preselected set pressure range at the outlet 66. The components and functioning of the actuator 62 are well understood in the art, and therefore further detailed description of the components and functionality thereof is not presented herein. Further, the teachings of the present disclosure are not limited to this particular type of actuator, but may also be used with other types of actuators.

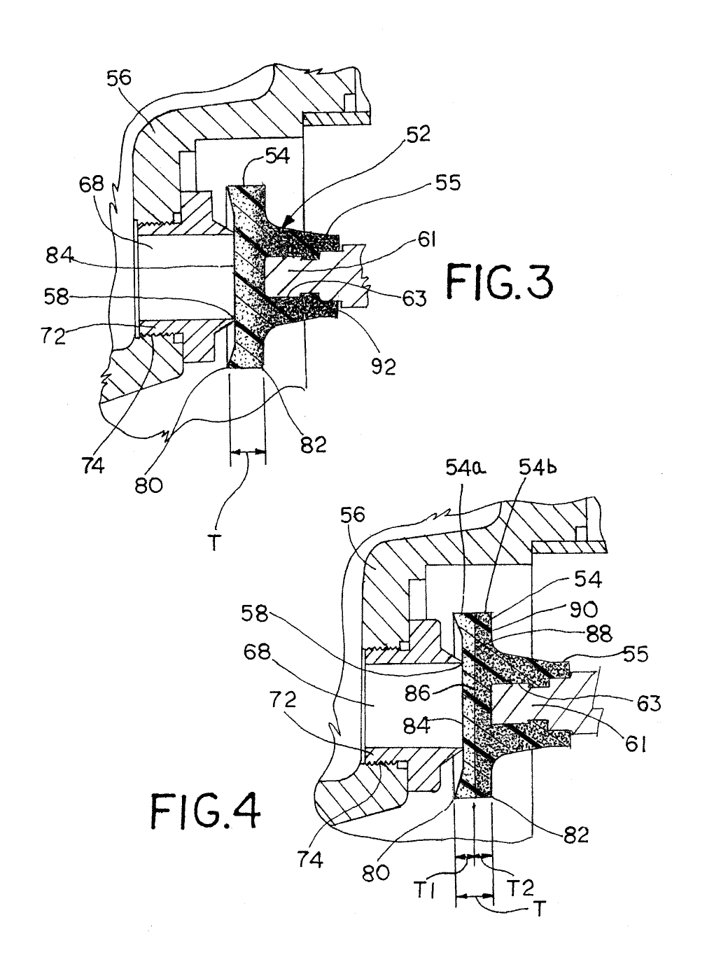

Turning now to the enlarged views of FIGS. 3 and 4, the seal disk 54 has a body with a thickness T extending between a front side 80 and a rear side 82, a seal face 84 defined by the front side 80, and the mounting portion 55 defined at or extending from the rear side 82. The flow control member 52 is in the closed position, and the seal face 84 is sealingly engaged against the valve seat 58. The seal disk 54 is made of elastomeric material, and the seal face 80 is compressed against the valve seat 58. The elastomeric material has a first hardness at the seal face 84 and a second hardness spaced apart from the seal face 80 along the thickness T. The elastomeric material is softer at the seal face and harder spaced away from the seal face toward the rear side 82. Put another way, the elastomeric material spaced away from the seal face 80 toward the rear side 82 is harder than the elastomeric material at the seal face 80.

In the exemplary arrangement of FIGS. 2 and 3, the elastomeric material forming the seal disk 54 has a hardness that changes gradually and continuously along the thickness T, from a softer hardness durometer at the seal face 84 to a harder hardness durometer at the rear side 82. Preferably, the hardness of the elastomeric material changes at a substantially constant gradient from the seal face 84 to a point spaced from the seal face 84, such as an intermediate thickness between the seal face 84 and the rear side 82, or all the way to the rear side 82. However, the hardness of the elastomeric material may change at a varying gradient along the thickness T. In one preferred arrangement, the elastomeric material has a hardness durometer rating of between about 40 and about 60 at the seal face 84, a hardness durometer rating of between about 70 and about 90 at the rear side 82 of the seal disk 54, and the hardness durometer changes at a substantially constant rate from the seal face 80 to the rear side 82.

In the exemplary arrangement of FIG. 4, the body of the seal disk 54 is formed of at least two layers of elastomeric material, a first layer 54a and a second layer 54b. The first layer 54a has a first side that defines the seal face 84 and a second side 86 opposite the seal face 84. The second layer 54b has a first side 88 and a second side 90 defining the rear side 82. The first side 88 of the second layer 54b faces the second side 86 of the first layer 54a. The second side 90 is coupled to the mounting portion 55, such as by being integral with or by being fastened thereto. The first layer 54a has a first hardness, and the second layer 54b has a second hardness that is harder than the first hardness of the first layer 54a. Put another way, the first layer 54a is softer than the second layer 54b.

Preferably, the first side 88 of the first layer 54a is secured to an adjacent layer, such as to the second side of the first layer 54a. Adjacent layers may be secured together, for example, with adhesive, a thermal weld, and/or a mechanical fastener or clamp. The first layer 54a has a first thickness T1. The second layer 54b has a second thickness T2. The thickness T of the seal disk 54 is equal to the sum of the thicknesses of the layers between the front side 80 and the rear side 82, such as the sum of T1 and T2. Although only two layers 54a, 54b are shown in the present example, the body may be formed of more than two layers stacked in succession such that the thickness T of the seal disk 54 is equal to the sum of the thicknesses of the layers. In such arrangement, one or more additional layers may be sandwiched between the first layer 54a and the second layer 54b. Alternatively or additionally, additional layers of elastomeric material may be stacked against the rear side 82 of the second layer 54b.

In one arrangement, each of the layers 54a, 54b has a constant hardness throughout its respective thickness T1 or T2. In one preferred arrangement, the first layer 54a has a hardness durometer of between approximately 40 and approximately 60. The second layer 54b has a hardness durometer of between approximately 70 and approximately 90. In another arrangement, the hardness of the elastomeric material in one or both of the layers 54a, 54b changes gradually and continuously along the thickness T, from a softer hardness durometer at or toward the seal face 84 to a harder hardness durometer toward the rear side 82. In either arrangement, the elastomeric material at the seal face 84 is preferably the softest elastomeric material and the elastomeric material spaced away from the seal face 84 toward the rear side 82 is harder than the elastomeric material at the seal face.

In each of the exemplary arrangements shown in FIGS. 2-4, the mounting portion 55 and the seal disk 54 may be formed as a single unitary piece with at least a portion of the seal disk 54, such as of a single molded piece of elastomeric material having a hardness gradient as described above. Alternatively, the mounting portion 55 may be a separate piece from seal disk 54 and coupled to the seal disk 54, such as with fasteners, adhesives, and/or welding. In the exemplary arrangement of FIG. 3, the seal disk 54 and the mounting portion 55 are a single unitary piece of molded elastomeric material, and the hardness of the elastomeric material continuously changes from a softest hardness durometer at the seal face 84 to a hardest hardness durometer at a distal end 92 of the mounting portion 55. In the exemplary arrangement of FIG. 4, the mounting portion 55 is a separate piece from the second layer 54b, may be made of elastomeric material, metal, or plastic, and is secured to the second layer 54b.

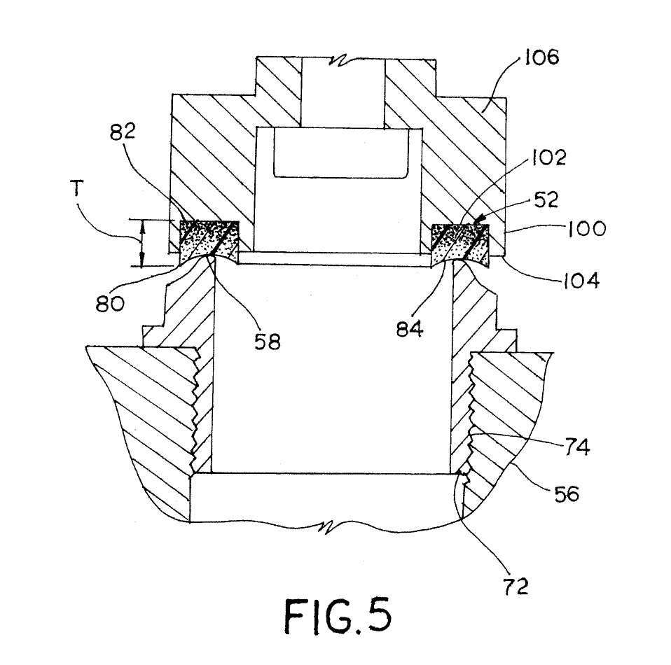

FIG. 5 shows another exemplary arrangement, wherein the seal disk 52 is in the shape of a circular ring and carried in a disk housing 100 defined by a seating portion 102, preferably in the form of a circular groove, defined at an end face 104 of a flow control element 106. The seal disk 52 is made of elastomeric material. The elastomeric material has a first hardness at the seal face 84 and a second hardness spaced away from the seal face along the thickness T toward the rear side 82, wherein the first hardness at the seal face 84 is softer than the second hardness. In this exemplary arrangement, the mounting portion is defined by the rear side 82 of the circular ring opposite the seal face 84. The hardness of the elastomeric material preferably changes continuously along the thickness from the seal face 84 toward—and preferably to—the rear side 82. In other arrangements, the seal disk 52 may be formed of two or more layers of elastomeric material of differing hardnesses, wherein the layer defining the seal face 84 is softer than the layers spaced from the seal face 84, in accordance with the teachings presented previously herein.

Other shapes and arrangements of the seal disk 52 may also be formed in accordance with the teachings of the present disclosure, and the disclosure is not limited to the specific shapes of the seal disk 52 and/or the overall flow control element 52 shown and described in the specific exemplary arrangements of the drawings.

A seal disk 54 according to the teachings of the present disclosure may, in some arrangements, improve the lockup performance of a fluid regulator, such as a gas regulator for use in residential, commercial, and/or industrial settings, particularly in low-force lockup arrangements. For example, such a seal disk in some arrangements may reduce the closing forces needed to achieve lockup of the valve while minimizing damage to the seal face caused by shearing forces, such as cutting and/or other damage, arising from compression against the valve seat. In some arrangements, the seal disk may provide one or more benefits such as providing a seal disk and/or a flow control element that is completely made of rubber or elastomeric material. The softer rubber may allow a low pressure clime to seal. The harder rubber may resist cutting and provide strong structural support to prevent excessive deformation of the overall shape of the seal disk. Such changes may improve overall performance of the fluid regulator. Such improvements may also provide similar benefits to other types of flow control valves.

Each of the optional arrangements described herein may be arranged in any set of combinations or permutations sufficient to provide any combination of one or more functionalities suggested by the description provided herein. Further, it is understood that each of the features disclosed with respect to each exemplary arrangement may be combined in any functional combination, such as to provide any useful combination of functionalities as would be understood by a person of ordinary skill.

Numerous modifications to the exemplary seal disks and flow control valves disclosed herein will be apparent to those skilled in the art in view of the foregoing description. Accordingly, this description is to be construed as illustrative only and is presented for the purpose of enabling those skilled in the art to make and use the invention and to teach the preferred mode of carrying out same. The exclusive rights to all modifications within the scope of the disclosure and the appended claims are reserved.

I claim:

1. A seal disk for a fluid flow control valve, comprising
a body having a thickness extending from a front side to a rear side;
a sealing surface defined at the front side, wherein the sealing surface is arranged to sealingly engage a valve seat;
the body comprising elastomeric material, the elastomeric material having a first hardness at the seal face and a second hardness spaced apart from the seal face along the thickness, wherein the first hardness is softer than the second hardness.

2. A seal disk in accordance with claim 1, wherein the hardness of the elastomeric material changes gradually between the seal surface and the body portion.

3. A seal disk in accordance with claim 2, wherein the hardness changes at a substantially constant gradient.

4. A seal disk in accordance with claim 2, wherein the hardness changes at a changing gradient.

5. A seal disk in accordance with claim 1, wherein the body is formed of a plurality of layers of elastomeric material, including at least a first layer having a first thickness and a second layer having a second thickness, wherein the seal surface is defined by the first layer, and wherein the first layer of elastomeric material has the first hardness, and the second layer has the second hardness.

6. A seal disk in accordance with claim 5, wherein at least a third layer of elastomeric material is secured to the second layer.

7. A seal disk in accordance with claim 5, wherein the first layer is secured to the second layer.

8. A seal disk in accordance with claim 5, wherein one or more of the first and second layers has a substantially constant hardness throughout the respective thickness.

9. A seal disk in accordance with claim 5, wherein one or more of the first and second layers has a gradually changing hardness across the respective thickness.

10. A seal disk in accordance with claim 1, wherein the fluid control valve comprises a fluid regulator and the valve body comprises a regulator body.

11. A flow control valve, comprising:
a valve body;
a valve seat operatively disposed in the valve body;
a valve stem having a first end disposed in the valve body and a second end arranged to be operatively coupled with an actuator; and
a flow control member comprising a seal disk, the flow control member operatively coupled to the first end of the valve stem, the seal disk comprising:
a body having a thickness extending from a front side to a rear side;
a sealing surface defined at the front side, wherein the sealing surface is arranged to sealingly engage the valve seat;
the body comprising elastomeric material, the elastomeric material having a first hardness at the seal face and a second hardness spaced apart from the seal face along the thickness;
wherein the first hardness is softer than the second hardness.

12. A flow control valve in accordance with claim 11, wherein the hardness of the elastomeric material changes gradually between the seal surface and the body portion.

13. A flow control valve in accordance with claim 11, wherein the body is formed of a plurality of layers of elastomeric material including at least a first layer of elastomeric material having a first thickness and a second layer of elastomeric material having a second thickness, the seal surface is defined by the first layer, and wherein the first layer has the first hardness, and the second layer has.

14. A flow control valve in accordance with claim 11, wherein the fluid control valve comprises a fluid regulator and the valve body comprises a regulator body.

15. A flow control valve in accordance with claim 14, further comprising an actuator operatively connected to the regulator body and to the second end of the valve stem.

16. A flow control valve in accordance with claim 11, wherein the elastomeric material comprises a rubber compound.
